(19) United States
(12) Patent Application Publication
(10) Pub. No.: US 2020/0183533 A1
(43) Pub. Date: Jun. 11, 2020

(54) DISPLAY APPARATUS, DISPLAY SYSTEM, AND DISPLAY METHOD

(71) Applicant: SEIKO EPSON CORPORATION, Tokyo (JP)

(72) Inventor: Taisuke YAMAUCHI, Matsumoto-shi (JP)

(73) Assignee: SEIKO EPSON CORPORATION, Tokyo (JP)

(21) Appl. No.: 16/703,930

(22) Filed: Dec. 5, 2019

(30) Foreign Application Priority Data
Dec. 6, 2018 (JP) 2018-229446

(51) Int. Cl. G06F 3/042; G06T 11/20; G06F 3/0354; G06T 7/70

(52) U.S. Cl. CPC G06F 3/0425; G06T 7/70; G06F 3/03542; G06T 11/20

(57) ABSTRACT

There is provided a projector including a position detecting section configured to detect the position of a pointer, a generating section configured to generate an image corresponding to a position of the pointer detected by the position detecting section while the pointer is in contact with a screen, a projecting section configured to display the image generated by the generating section, a speed calculating section configured to calculate moving speed of the pointer, and a drawing determining section configured to determine a form of the image based on the moving speed of the pointer. The drawing determining section determines, based on moving speed of the pointer before coming into contact with the screen, a form of the image corresponding to the position of the pointer detected when coming into contact with the screen.

The present application is based on, and claims priority from JP Application Serial Number 2018-229446, filed Dec. 6, 2018, the disclosure of which is hereby incorporated by reference herein in its entirety.

### BACKGROUND

### 1. Technical Field

The present disclosure relates to a display apparatus, a display system, and a display method.

### 2. Related Art

There has been known a display apparatus that detects a pointed position of a pointer and displays an image corresponding to the detected pointed position.

For example, an electronic information drawing apparatus disclosed in JP A-2003-162369 (Patent Literature 1) changes the thickness, the transparency, and a drawing range of a line based on a movement amount per unit time of an input position indicated by coordinate information detected by an input device.

### SUMMARY

An advantage of the present disclosure is to make it possible to change a form of an image to a form corresponding to operation of a pointer.

An aspect of the present disclosure is directed to a display apparatus including: a position detecting section configured to detect a position of a pointer; a generating section configured to generate an image corresponding to a position of the pointer detected by the position detecting section while the pointer is in contact with an input surface; a display section configured to display the image generated by the generating section; a speed calculating section configured to calculate moving speed of the pointer; and a drawing determining section configured to determine a form of the image based on the moving speed of the pointer. The drawing determining section determines, based on moving speed of the pointer before coming into contact with the input surface, a form of the image corresponding to a position of the pointer detected when coming into contact with the input surface.

In the display apparatus, the drawing determining section may determine the form of the image based on a difference between the moving speed of the pointer before coming into contact with the input surface and moving speed of the pointer after coming into contact with the input surface.

In the display apparatus, the generating section may draw a line serving as the image along a track of the position of the pointer, and the drawing determining section may determine at least one of line width, chroma, and transmittance of a line to be drawn.

In the display apparatus, the drawing determining section may calculate a weighted value for changing at least one of the line width, the chroma, and the transmittance of the line to be drawn to a value corresponding to a change in the moving speed of the pointer and determine at least one of the line width, the chroma, and the transmittance based on the calculated weighted value.

In the display apparatus, the drawing determining section may calculate a first weighted value as the weighted value when moving speed of the pointer when coming into contact with the input surface is equal to or larger than a threshold and calculate a second weighted value as the weighted value when the moving speed of the pointer when coming into contact with the input surface is smaller than the threshold, the first weighted value may decrease when the moving speed of the pointer changes in an increasing direction, and the second weighted value may increase when the moving speed of the pointer changes in the increasing direction.

In the display apparatus, the display apparatus may further include an imaging section configured to image a range including the input surface, and the position detecting section may detect the position of the pointer based on a captured image obtained by imaging light of the pointer that emits light.

In the display apparatus, the imaging section may perform imaging in synchronization with a light emission cycle of the pointer that cyclically emits light.

In the display apparatus, the input surface may be a display surface of the display section.

Another aspect of the present disclosure is directed to a display system including: a pointer; a position detecting section configured to detect a position of the pointer; a generating section configured to generate an image corresponding to a position of the pointer detected by the position detecting section while the pointer is in contact with an input surface; a display section configured to display the image generated by the generating section; a speed calculating section configured to calculate moving speed of the pointer; and a drawing determining section configured to determine a form of the image based on the moving speed of the pointer. The drawing determining section determines, based on moving speed of the pointer before coming into contact with the input surface, a form of the image corresponding to a position of the pointer detected when coming into contact with the input surface.

Still another aspect of the present disclosure is directed to a display method including: detecting a position of a pointer; generating an image corresponding to the position of the pointer detected while the pointer is in contact with an input surface; displaying the generated image; calculating moving speed of the pointer; and determining a form of the image based on the moving speed of the pointer. In the determining the form of the image, a form of the image corresponding to a position of the pointer detected when coming into contact with the input surface is determined based on moving speed of the pointer before coming into contact with the input surface.

### BRIEF DESCRIPTION OF THE DRAWINGS

FIG. 1 is a schematic configuration diagram of a display system.

FIG. 2 is a block diagram showing the configuration of a pointer.

FIG. 3 is a block diagram showing the configuration of a projector.

FIG. 4 is a diagram showing imaging periods of an imaging section and light emission timing of the pointer.

FIG. 5 is a diagram showing a weighted value curve.

FIG. 6 is a diagram showing an operation method of the pointer with respect to a screen.

FIG. 7 is a diagram showing an operation method of the pointer with respect to the screen.

FIG. 8 is a diagram showing a drawn image displayed on the screen.

FIG. 9 is a diagram showing a drawn image displayed on the screen.

FIG. 10 is a flowchart showing the operation of the pointer.

FIG. 11 is a flowchart showing the operation of a projector in a first embodiment.

FIG. 12 is a diagram showing a weighted value curve.

FIG. 13 is a flowchart showing the operation of a projector in a second embodiment.

### DESCRIPTION OF EXEMPLARY EMBODIMENTS

### First Embodiment

### Overview of a Projection System

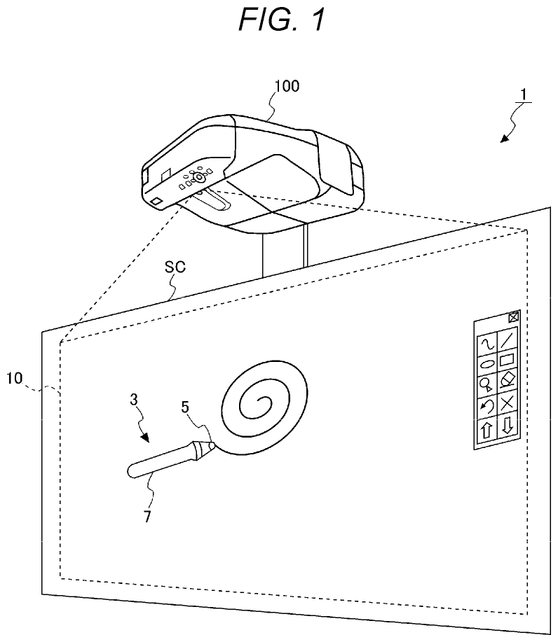

FIG. 1 is a schematic configuration diagram of a display system 1 in a first embodiment.

The display system 1 includes a pointer 3 functioning as a pointing tool and a projector 100 operating as a display apparatus that displays an image in a pointed position pointed by the pointer 3.

The projector 100 is set on a wall above or obliquely above a screen SC and projects an image toward the screen SC below the projector 100. A setting method for the projector 100 is not limited to wall hanging setting for setting the projector 100 on the wall and may be flat placing setting for placing the projector 100 flat on a desk, a table, or a floor and ceiling suspended setting for suspending the projector 100 from a ceiling. The screen SC is a display surface on which an image projected by the projector 100 is displayed and is an input surface on which operation by the pointer 3 is received. The screen SC is a flat plate and a curtain fixed to a wall or erected on a floor surface. A projection surface onto which the projector 100 projects an image is not limited to the screen SC. For example, a wall surface of a building or the like can also be used as the screen SC.

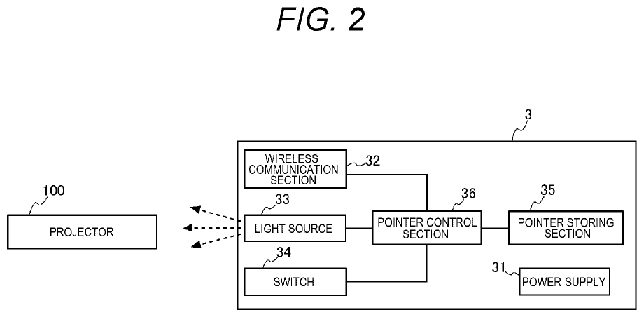

The pointer 3 is a pen-type pointing tool including a light source 33 shown in FIG. 2. The pointer 3 causes the light source 33 to emit light at a preset cycle. A user holds a shaft section 7 of the pointer 3, moves the pointer 3 on the screen SC while bringing a tip 5 into contact with the screen SC, and draws a point, a line, a character, a sign, or a figure on the screen SC. The projector 100 has a position detecting function and detects light emitted by the light source 33 and detects a position on the screen SC pointed by the pointer 3. The projector 100 causes the screen SC to display an image corresponding to a track of a pointed position pointed by the pointer 3. In the following explanation, an image of the point, the line, the character, the sign, the figure, or the like drawn by the pointer 3 is referred to as drawn image. Data generated by the projector 100 in order to cause the screen SC to display the drawn image is referred to as drawn image data.

In FIG. 1, only one pointer 3 is shown. However, the projector 100 can distinguish lights respectively emitted by a plurality of pointers 3 and display drawn images in pointed positions of the pointers 3. Therefore, a plurality of users can respectively hold the pointers 3 and operate the pointers 3 to cause the screen SC to display images. In order to cause the projector 100 to distinguish the lights respectively emitted by the plurality of pointers 3, the plurality of pointers 3 may be caused to emit lights at timings different from one another. The projector 100 distinguishes pointed positions of the plurality of pointers 3 based on the light emission timings of the pointers 3.

### Configuration of the Pointer

FIG. 2 is a block diagram showing the configuration of the pointer 3.

The pointer 3 includes a power supply 31, a wireless communication section 32, a light source 33, a switch 34, a pointer storing section 35, and a pointer control section 36.

The power supply 31 is coupled to the wireless communication section 32, the light source 33, the switch 34, the pointer storing section 35, and the pointer control section and supplies electric power to the coupled sections. Illustration of a power supply line for coupling the sections of the pointer 3 and the power supply 31 is omitted. The pointer 3 includes a power button for turning on and off the power supply 31. Illustration of the power button is omitted. When the power button is turned on, the power supply 31 supplies electric power to the sections of the pointer 3. When the power button is turned off, the power supply 31 stops the supply of the electric power.

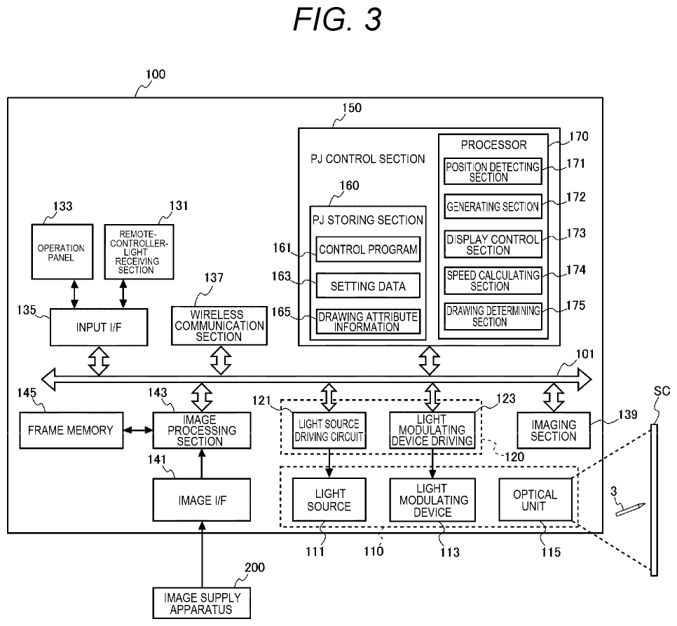

The wireless communication section 32 performs wireless communication with a wireless communication section 137 of the projector 100 shown in FIG. 3. As a communication scheme of the wireless communication section 32, for example, Bluetooth or Wi-Fi can be adopted. Bluetooth and Wi-Fi are registered trademarks.

The light source 33 includes a light emitting body such as an infrared LED (Light Emitting Diode). The switch 34 is a switch-type sensor that is turned on when pressure is applied to the tip 5 and is turned off when the pressure applied to the tip 5 is released.

The pointer storing section 35 is configured by a nonvolatile semiconductor memory such as a flash memory. The pointer storing section 35 stores, for example, data received from the projector 100 and data used for calculation by the pointer control section 36.

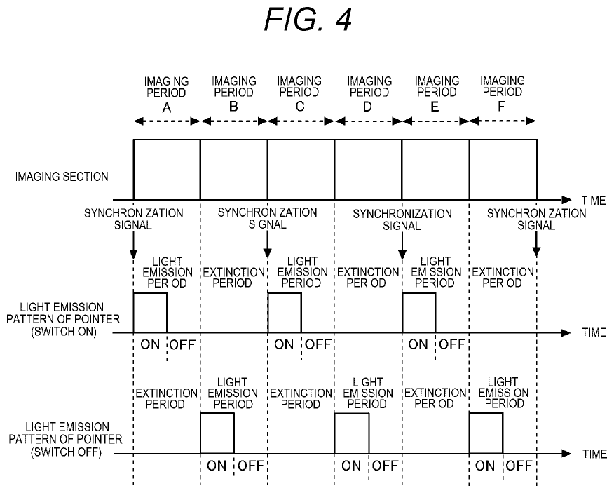

The pointer control section 36 includes a not-shown processor. The processor executes a control program stored in the pointer storing section 35 to realize functions of the pointer control section 36 explained below. The pointer control section 36 may be configured by a dedicated hardware circuit. The pointer control section 36 is coupled to the wireless communication section 32, the light source 33, the switch 34, and the pointer storing section 35 by a signal line. The pointer control section 36 determines light emission timing of the light source 33 based on a state of the switch 34 and a synchronization signal received by the wireless communication section 32 from the projector 100. The pointer control section 36 causes the light source 33 to emit light both when the tip 5 is in contact with the screen SC and the switch 34 is on and when the tip 5 separates from the screen SC and the switch 34 is off. The pointer control section 36 changes the light emission timing of the light source 33 between when the switch 34 is on and when the switch 34 is off. Details of the light emission timing are explained below with reference to FIG. 4.

### Configuration of the Projector

FIG. 3 is a block diagram showing the configuration of the projector 100.

The projector 100 includes, as major components, an image projection system that generates image light and projects the image light onto the screen SC, an image processing system that electrically processes image data, which is a source of an optical image, and a PJ control section 150 that controls the sections.

The image projection system includes a projecting section 110 and a driving section 120. The projecting section 110 includes a light source 111, a light modulating device 113, and an optical unit 115. The driving section 120 includes a light source driving circuit 121 and a light modulating device driving circuit 123. The light source driving circuit 121 and the light modulating device driving circuit 123 are coupled to a bus 101. The light source driving circuit 121 and the light modulating device driving circuit 123 mutually perform, via the bus 101, data communication with the other functional sections such as the PJ control section 150 also coupled to the bus 101.

As the light source 111, a lamp such as a halogen lamp, a Xenon lamp, or an ultrahigh pressure mercury lamp is used. A solid-state light source such as an LED (Light Emitting Diode) or a laser beam source may be used as the light source 111.

The light source 111 is coupled to the light source driving circuit 121. The light source driving circuit 121 supplies a driving current and a pulse to the light source 111 to drive the light source 111.

The light modulating device 113 includes light modulating elements that modulate light emitted by the light source 111 to generate image lights. The light modulating device 113 emits the image lights generated by the light modulating elements to the optical unit 115. As the light modulating elements, for example, a liquid crystal light valve of a transmission type, a liquid crystal light valve of a reflection type, and a digital mirror device can be used.

The light modulating device 113 is coupled to the light modulating device driving circuit 123. The light modulating device driving circuit 123 drives the light modulating device 113 and causes the light modulating elements to draw images in frame units. For example, when the light modulating device 113 is configured by the liquid crystal light valve, the light modulating device driving circuit 123 is configured by a driver circuit that drives liquid crystal.

The optical unit 115 includes optical elements such as a lens and a mirror and projects image light modulated by the light modulating device 113 toward the screen SC. An image based on the image light projected by the optical unit 115 is formed on the screen SC. An image projected onto the screen SC by the projecting section 110 is referred to as projection image. A range on the screen SC in which the projecting section 110 projects the projection image is referred to as projection region 10. The projection region 10 indicates a largest region of the screen SC on which the projector 100 is capable of projecting the projection image. The projection region 10 is, for example, a region of the screen SC corresponding to an entire region usually used in the light modulating elements of the light modulating device 113.

The projector 100 includes a remote-controller-light receiving section 131, an operation panel 133, and an input interface 135. The input interface 135 is coupled to the bus 101 and mutually performs data communication with the other functional sections such as the PJ control section 150 via the bus 101.

The remote-controller-light receiving section 131 receives an infrared signal transmitted by a not-shown remote controller. The remote-controller-light receiving section 131 outputs an operation signal corresponding to the received infrared signal. The input interface 135 outputs the input operation signal to the PJ control section 150. The operation signal is a signal corresponding to an operated switch of the remote controller.

The operation panel 133 is disposed in, for example, a housing of the projector 100 and includes various switches. When a switch of the operation panel 133 is operated, the input interface 135 outputs an operation signal corresponding to the operated switch to the PJ control section 150. In FIG. 3, the input interface 135 is abbreviated as input I/F 135.

The projector 100 includes a wireless communication section 137 and an imaging section 139. The wireless communication section 137 and the imaging section 139 are coupled to the bus 101 and mutually perform data communication with the other functional sections such as the PJ control section 150 via the bus 101.

The wireless communication section 137 performs wireless communication with the wireless communication section 32 of the pointer 3. As a communication scheme of the wireless communication, a short range wireless communication scheme such as Bluetooth or Wi-Fi can be adopted.

The imaging section 139 images at least a range including the projection region 10 and generates imaging data. The imaging data corresponds to an example of the “captured image” in the aspect of the present disclosure. The imaging section 139 includes an infrared imaging element that images infrared light and an interface circuit and performs imaging by the infrared light. As the imaging element, both of a CCD and a CMOS can be used. Other elements can also be used. An imaging direction and an imaging range of the imaging section 139 face the same direction or substantially the same direction as the optical unit 115 and cover the projection region 10 in which the optical unit 115 projects an image onto the screen SC.

The image processing system of the projector 100 is explained.

The projector 100 includes, as the image processing system, an image interface 141, an image processing section 143, and a frame memory 145. The image processing section 143 is coupled to the bus 101 and mutually performs data communication with the other functional sections such as the PJ control section 150 via the bus 101.

The image interface 141 is an interface into which image data is input and includes a connector to which a not-shown transmission cable is coupled and an interface circuit that receives image data via the transmission cable. The image interface 141 outputs the received image data to the image processing section 143. In FIG. 3, the image interface 141 is abbreviated as image I/F 141.

An image supply apparatus 200 that supplies image data is coupled to the image interface 141. As the image supply apparatus 200, for example, a notebook PC (Personal Computer), a desktop PC, a tablet terminal, a smartphone, and a PDA (Personal Digital Assistant) can be used. The image supply apparatus 200 may be a video player, a DVD player, a Blu-ray disk player, or the like. Further, the image supply apparatus 200 may be a hard disk recorder, a television tuner device, a set-top box of a CATV (Cable television), or a video game machine. The image data input to the image interface 141 may be either moving image data or still image data. A format of data is optional.

The image processing section 143 and the frame memory 145 are configured by, for example, an integrated circuit. The integrated circuit includes an LSI (Large-Scale Integrated CIRCUIT), an ASIC (Application Specific Integrated Circuit), a PLD (Programmable Logic Device), an FPGA (Field-Programmable Gate Array), and an SoC (System-on-a-chip). An analog circuit may be included in a part of the configuration of the integrated circuit.

The image processing section 143 is coupled to the frame memory 145. The image processing section 143 develops, on the frame memory 145, image data input from the image interface 141 and performs image processing on the developed image data.

The image processing section 143 executes various kinds of processing including, for example, geometric correction processing for correcting trapezoidal distortion of a projection image and OSD processing for superimposing an OSD (On Screen Display) image. The image processing section 143 may execute, on the image data, other kinds of image processing such as image adjustment processing for adjusting luminance and a tint, resolution conversion processing for adjusting an aspect ratio and resolution of the image data according to the light modulating device 113, and frame rate conversion.

The image processing section 143 outputs the image data after the image processing to the light modulating device driving circuit 123. The light modulating device driving circuit 123 generates driving signals for each color of R, G, and B based on the image data input from the image processing section 143. The light modulating device driving circuit 123 drives, based on the generated driving signals of R, G, and B, the light modulating elements of the light modulating device 113 of the colors corresponding to the driving signals and causes the light modulating elements of the colors to draw images. Light emitted from the light source 111 passes through the light modulating elements, whereby image lights corresponding to the images of the image data are generated.

The PJ control section 150 includes a PJ storing section 160 and a processor 170.

The PJ storing section 160 is configured by, for example, a nonvolatile semiconductor memory such as a flash memory or an EEPROM or an SSD (Solid State Drive) in which the flash memory is used. The PJ storing section 160 stores a control program 161, setting data 163, and drawing attribute information 165.

The control program 161 is a program executed by the processor 170 and includes, for example, an operating system and application programs. The application programs include an application program for realizing an interactive function. The interactive function is a function of detecting a pointed position of the pointer 3 and causing the screen SC to display an image corresponding to the detected pointed position. The interactive function includes a function of causing the screen SC to display an icon for selecting processing executable by the pointer 3 and a function of executing processing associated with the icon selected by the pointer 3. Icons include, for example, an eraser icon and an icon for changing a color of a drawn image. For example, when the eraser icon is selected, the PJ control section 150 erases, from the screen SC, the drawn image displayed in the pointed position of the pointer 3.

The setting data 163 is data in which processing conditions of various kinds of processing executed by the processor 170 are set. The setting data 163 may include data of setting concerning image processing executed by the image processing section 143.

The drawing attribute information 165 is information that defines a correlation between line width, chroma, and transmittance of a drawing line and moving speed of the pointer 3. Details of the drawing attribute information 165 are explained below. The drawing line is an example of a drawn image and is a line drawn on the screen SC by operation of the pointer 3. When operation by a plurality of pointers 3 is enabled, the drawing attribute information 165 may be set differently for each of the pointers 3 or may be set in common in the plurality of pointers 3.

The processor 170 is an arithmetic processing device configured by, for example, a CPU (Central Processing Unit), a DSP (Digital Signal Processor), or a microcomputer. The processor 170 may be configured by a single processor or may be configured by a combination of a plurality of processors.

The PJ control section 150 causes the processor 170 to execute the control program 161 to realize various functions. In FIG. 3, functional blocks respectively corresponding to functions of the PJ control section 150 are shown. The processor 170 in this embodiment includes, as the functional blocks, a position detecting section 171, a generating section 172, a display control section 173, a speed calculating section 174, and a drawing determining section 175.

The position detecting section 171 causes the imaging section 139 to execute imaging and acquires imaging data generated by the imaging section 139. The imaging section 139 performs imaging according to an instruction of the position detecting section 171 and outputs imaging data generated by the imaging to the PJ control section 150. The position detecting section 171 causes the PJ storing section 160 to temporarily store the imaging data input from the imaging section 139.

The position detecting section 171 reads out the imaging data stored in the PJ storing section 160, analyzes the read-out imaging data, and detects a pointed position of the pointer 3. The position detecting section 171 outputs, as the pointed position, a coordinate indicating a position on the imaging data where an image of infrared light emitted by the pointer 3 is captured. The pointed position output by the position detecting section 171 is input to the generating section 172, the speed calculating section 174, and the drawing determining section 175.

The pointed position is sequentially input to the generating section 172 from the position detecting section 171. The generating section 172 converts the coordinate on the imaging data, which is the input pointed position, into a coordinate on the frame memory 145. The PJ storing section 160 stores, as the setting data 163, conversion data for converting the coordinate of the imaging data into the coordinate of the frame memory 145. The conversion data may be created and stored in the PJ storing section 160 during shipment of a product. Alternatively, the projector 100 may perform calibration to generate the conversion data before projection of an image. The generating section 172 converts, based on the conversion data, the coordinate of the imaging data into the coordinate of the frame memory 145.

The generating section 172 generates drawn image data according to drawing parameters determined by the drawing determining section 175 explained below. The drawn image data is data of a drawing line corresponding to a track of a pointed position pointed by the pointer 3. The data of the drawing line generated by the generating section 172 is referred to as drawing line data.

The drawing parameters are parameters that decide a form of a drawn image. More specifically, the drawing parameters are parameters that decide at least one of the line width, the chroma, and the transmittance of the drawing line. The transmittance is a numerical value for defining transparency of an image and is represented as an alpha value as well. In this embodiment, a parameter that defines line width and a parameter that defines chroma are defined as the drawing parameters. Generation of drawn image data performed by the generating section 172 according to these parameters is explained below.

The generating section 172 outputs the generated drawn image data and coordinate information indicating the converted coordinate of the frame memory 145 to the image processing section 143. The image processing section 143 develops the input drawn image data in a coordinate of the frame memory 145 indicated by the input coordinate information. When image data received by the image interface 141 has already been developed on the frame memory 145, the image processing section 143 superimposes and develops the drawn image data on the developed image data. When the development of the drawn image data is completed, the image processing section 143 reads out data from the frame memory 145 and outputs the read-out data to the light modulating device driving circuit 123. In the following explanation, drawn image data, which is data read out from the frame memory 145 by the image processing section 143, or image data and the drawn image data are collectively referred to as developed data.

The display control section 173 controls the image processing section 143, the light source driving circuit 121, and the light modulating device driving circuit 123 to project a projection image onto the screen SC. For example, the display control section 173 causes the projecting section 110 to display, on the screen SC, an image based on image data received by the image interface 141. Specifically, the display control section 173 reads out parameters corresponding to image processing, which the display control section 173 causes the image processing section 143 to execute, from the PJ storing section 160, outputs the read-out parameters to the image processing section 143, and causes the image processing section 143 to execute the image processing. The parameters corresponding to the image processing are data included in the setting data 163.

The display control section 173 causes the image processing section 143 to read out developed data from the frame memory 145 and output the read-out developed data to the light modulating device driving circuit 123. Further, the display control section 173 causes the light modulating device driving circuit 123 to operate and cause the light modulating elements of the light modulating device 113 to draw images based on the developed image input from the image processing section 143.

The speed calculating section 174 calculates moving speed of the pointer 3 operated by the user. The speed calculating section 174 calculates the moving speed of the pointer 3 both when the pointer 3 is in contact with the screen SC and when the pointer 3 is not in contact with the screen SC.

FIG. 4 is a diagram showing imaging periods of the imaging section 139 and light emission timing of the pointer 3.

Before a calculation method with which the speed calculating section 174 calculates moving speed of the pointer 3 is specifically explained, light emission timing of the pointer 3 and imaging periods in which the imaging section 139 performs imaging are explained.

When the power button is turned on, the pointer 3 causes the light source 33 to cyclically emit light. A light emission cycle of the light source 33 includes a light emission period and an extinction period. A period in which the light source 33 emits light is referred to as light emission period. A period in which the light source 33 is extinguished is referred to as extinction period. In this embodiment, temporal lengths of the light emission period and the extinction period are set to the same length. However, the temporal lengths of the light emission period and the extinction period may be set to different lengths.

The pointer 3 causes the light source 33 to emit light in a fixed period in the light emission period rather than causing the light source 33 to emit light in all periods in the light emission period. A time in which the light source 33 emits light in the light emission period is referred to as ON time and a time in which the light source 33 is extinguished is referred to as OFF time.

The pointer 3 causes the light source 33 to emit light at different timings in the cases of ON and OFF of the switch 34. In this embodiment, the pointer 3 shifts the light emission timing by a half cycle between the case of ON and the case of OFF of the switch 34. That is, a light emission period in the case of ON of the switch 34 coincides with an extinction period in the case of OFF of the switch 34. An extinction period of ON of the switch 34 coincides with a light emission period in the case of ON of the switch 34.

The pointer control section 36 determines, based on a synchronization signal received by the wireless communication section 32 from the projector 100 and a state of the switch 34, light emission timing when the pointer control section 36 causes the light source 33 to emit light and a light emission time.

The position detecting section 171 of the projector 100 transmits a synchronization signal with the wireless communication section 137. When the synchronization signal is received and the switch 34 is on, the pointer control section 36 sets, as the ON time, a fixed time immediately after the reception of the synchronization signal. When the synchronization signal is received and the switch 34 is off, the pointer control section 36 sets, as the ON time, a fixed time after elapse of a preset setting time from the reception of the synchronization signal. The preset setting time corresponds to an elapsed time of the light emission period.

For example, it is assumed that both of the light emission period and the extinction period are 8 msec, the ON time and the OFF time are 4 msec, and the light emission cycle of the pointer 3 is 16 msec. When the switch 34 is on, the pointer control section 36 sets, as the ON time, a period of 4 msec immediately after the reception of the synchronization signal and causes the light source 33 to emit light. A light emission pattern of the light source 33 for causing the light source 33 to emit light for the fixed time immediately after the reception of the synchronization signal is referred to as first light emission pattern.

When the switch 34 is off, the pointer control section 36 causes the light source 33 to emit light at timing when 8 msec elapses from the reception of the synchronization signal. The pointer control section 36 extinguishes the light source 33 when 12 msec elapses from the reception of the synchronization signal. Alight emission pattern of the light source 33 for causing the light source 33 to emit light for the fixed time after the elapse of the setting time from the reception of the synchronization signal is referred to as second light emission pattern.

The position detecting section 171 causes the imaging section 139 to execute imaging twice from when the synchronization signal is transmitted until when the next synchronization signal is transmitted. A period in which the imaging section 139 performs imaging and generates imaging data of one frame is referred to as imaging period. The imaging period coincides with the light emission period and the extinction period of the pointer 3. That is, the imaging section 139 performs the imaging twice in one light emission cycle of the pointer 3. In the imaging performed twice, imaging immediately after the transmission of the synchronization signal is referred to as first imaging and imaging after the first imaging is referred to as second imaging. When the switch 34 of the pointer 3 is on, emitted light of the light source 33 is imaged in imaging data of the first imaging. When the switch 34 of the pointer 3 is off, emitted light of the light source 33 is imaged in imaging data of the second imaging.

Returning to the explanation of the speed calculating section 174, a calculation method for moving speed of the pointer 3 is explained.

The speed calculating section 174 calculates moving speed of the pointer 3 based on a pointed position detected by the position detecting section 171 and imaging timing of imaging data. For example, it is assumed that emitted light of the pointer 3 is imaged in an imaging period A and an imaging period C shown in FIG. 4. Imaging periods A, C, and E shown in FIG. 4 correspond to the first imaging and imaging periods B, D, and F shown in FIG. 4 correspond to the second imaging.

First, the speed calculating section 174 calculates a distance between a pointed position detected from imaging data of the imaging period A and a pointed position detected from imaging data of the imaging period C. The calculated distance between the pointed positions corresponds to a moving distance in which the pointer 3 moves in the imaging period A to the imaging period C.

Subsequently, the speed calculating section 174 calculates, as an elapsed time, a difference between times when the imaging data of the imaging period A and the imaging data of the imaging period C are captured. For example, the speed calculating section 174 may calculate, as the elapsed time, a difference between start time of the imaging period A and start time of the imaging period C or may calculate, as the elapsed time, a difference between end time of the imaging period A and end time of the imaging period C.

After calculating the moving distance of the pointer 3 and the elapsed time, the speed calculating section 174 divides the moving distance of the pointer 3 by the elapsed time and calculates moving speed during a contact time when the pointer 3 is in contact with the screen SC.

It is assumed that emitted light of the pointer 3 is imaged in the imaging period B and the imaging period D shown in FIG. 4. In this case as well, the speed calculating section 174 calculates a distance between pointed positions detected from respective imaging data of the imaging periods B and D and calculates, as an elapsed time, a difference between times when the imaging data of the imaging periods B and D are captured. The speed calculating section 174 divides the calculated moving distance of the pointer 3 by the elapsed time and calculates moving speed at a noncontact time when the pointer 3 is not in contact with the screen SC.

A processing operation of the speed calculating section 174 is specifically explained. When a pointed position is input from the position detecting section 171, the speed calculating section 174 determines whether the input pointed position is a pointed position at the contact time or a pointed position at the noncontact time. In this determination, the speed calculating section 174 determines whether imaging data used for detection of the pointed position is data of the first imaging or data of the second imaging.

It is assumed that a pointed position input this time is a pointed position (n), a pointed position input last time is a pointed position (n−1), a pointed position input before the last is a pointed position (n−2), and a pointed position input next time is a pointed position (n+1). “n” is any integer equal to or larger than 1.

When the input pointed position (n) is the pointed position at the contact time, the speed calculating section 174 determines whether the pointed position (n−1) input last time is the pointed position at the noncontact time. When the pointed position (n−1) of the last time is the pointed position at the contact time, the speed calculating section 174 calculates, as a moving distance, a difference between the pointed positions (n−1) and (n) of the last time and this time and calculates, as an elapsed time, a difference between imaging times of the imaging data of the last time and this time. The speed calculating section 174 divides the calculated moving distance by the calculated elapsed time and calculates moving speed of the pointer 3. The speed calculating section 174 causes the PJ storing section 160 to store the calculated moving speed as moving speed at the contact time.

When the pointed position (n−1) input last time is the pointed position at the noncontact time, the speed calculating section 174 does not perform calculation of moving speed of the pointer 3 and stays on standby until the next pointed position (n+1) is input. When the next pointed position (n+1) is input, the speed calculating section 174 determines whether the input next pointed position (n+1) is the pointed position at the contact time. When the input next pointed position (n+1) is the pointed position at the contact time, the speed calculating section 174 calculates a difference between the pointed positions (n) and (n+1) as a moving distance and calculates, as an elapsed time, a difference between imaging times of imaging data in which pointed positions (n) and (n+1) are detected. The speed calculating section 174 divides the calculated moving speed by the calculated elapsed time and calculates moving speed of the pointer 3. The speed calculating section 174 causes the PJ storing section 160 to store the calculated moving speed as moving speed at the contact time.

When the pointed position (n) input this time is the pointed position at the noncontact time, the speed calculating section 174 also determines whether the pointed position (n−1) input last time is the pointed position at the contact time or is the pointed position at the noncontact time. When the pointed position (n−1) input last time is the pointed position at the noncontact time, the speed calculating section 174 calculates a difference between the pointed positions (n−1) and (n) of the last time and this time as a moving distance and calculates a difference between imaging times of imaging data of the last time and this time as an elapsed time. The speed calculating section 174 divides the calculated moving distance by the elapsed time and calculates moving speed of the pointer 3. The speed calculating section 174 causes the PJ storing section 160 to store the calculated moving speed as moving speed at the noncontact time.

When the pointed position (n−1) input last time is the pointed position at the contact time, the speed calculating section 174 does not calculate moving speed of the pointer 3 and stays on standby until the next pointed position (n+1) is input. When the next pointed position (n+1) is input, the speed calculating section 174 determines whether the input next pointed position (n+1) is the pointed position at the noncontact time. When the input next pointed position (n+1) is the pointed position at the noncontact time, the speed calculating section 174 calculates a difference between the pointed positions (n) and (n+1) as a moving distance and calculates, as an elapsed time, a difference between imaging times of imaging data in which the pointed positions (n) and (n+1) are detected. The speed calculating section 174 divides the calculated moving distance by the calculated elapsed time and calculates moving speed of the pointer 3. The speed calculating section 174 causes the PJ storing section 160 to store the calculated moving speed as moving speed at the noncontact time.

The drawing determining section 175 is explained.

First, drawing parameters determined by the drawing determining section 175 are explained. The drawing determining section 175 calculates a weighted value based on the drawing attribute information 165 read out from the PJ storing section 160 and the moving speed of the pointer 3 calculated by the speed calculating section 174 and determines drawing parameters based on the calculated weighted value.

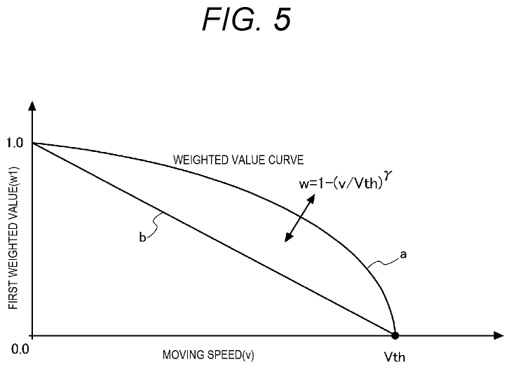

FIG. 5 is a diagram showing a weighted value curve. The vertical axis of FIG. 5 indicates a first weighted value w1 and the horizontal axis of FIG. 5 indicates moving speed v of the pointer 3. The weighted value indicates a rate of changing line width or chroma according to the moving speed of the pointer 3 using, as a reference value, line width or chroma at time when the moving speed of the pointer 3 is the reference moving speed. In this embodiment, line width or chroma at the time when the reference moving speed is “0”, that is, the pointer 3 is stopped is set as the reference value. When the moving speed of the pointer 3 is “0”, the first weighted value w1 is set to a maximum value “1.0”. When the moving speed of the pointer 3 is a threshold “Vth”, the first weighted value w1 is set to a minimum value “0.0”. The first weighted value w1 can be calculated by the following Expression (1) using, for example, the moving speed “v” of the pointer 3, the threshold “Vth” of the moving speed, and gamma “γ” as variables.

w1=1−(v/Vth)^{γ} (1)

The drawing attribute information 165 is information that defines a correlation between the moving speed of the pointer 3 and line width and chroma of a drawing line. The drawing attribute information 165 includes the gamma “γ” and the threshold “Vth” of the moving speed. The gamma “γ” is a variable that gives distortion by a gamma characteristic to the first weighted value w1. By changing a value of the gamma, a weighted value curve convex upward like a curved “a” shown in FIG. 5 can be formed or a weighted value curve linearly changing like a curve “b” shown in FIG. 5 can be formed.

The threshold “Vth” of the moving speed defines moving speed of the pointer 3 at which the first weighted value w1 is “0”. The drawing determining section 175 calculates the first weighted value w1 by substituting, in the above Expression (1), the moving speed “v” calculated by the speed calculating section 174 and “7” and “Vth” included in the drawing attribute information 165.

After calculating the first weighted value w1, the drawing determining section 175 multiplies preset line width by the calculated first weighted value w1. As the preset line width of the drawing line, for example, a maximum value of line width drawable by the pointer 3 is used. The preset line width is line width at the time when the moving speed of the pointer 3 is “0”. The drawing determining section 175 determines, as a drawing parameter that defines the line width of the drawing line, line width obtained by multiplying the preset line width of the drawing line by the calculated first weighted value w1. Similarly, concerning the chroma, the drawing determining section 175 determines, as a drawing parameter that defines the chroma of the drawing line, a value obtained by multiplying a value of preset chroma by the first weighted value w1. After determining the drawing parameters, the drawing determining section 175 notifies the determined drawing parameters to the generating section 172.

The drawing determining section 175 changes the moving speed of the pointer 3 used for determination of drawing parameters according to whether the pointed position input from the position detecting section 171 is the pointed position at the contact time or the pointed position at the noncontact time.

When a pointed position is input, the drawing determining section 175 determines whether the input pointed position is the pointed position at the contact time or the pointed position at the noncontact time. When the input pointed position is the pointed position at the contact time, the drawing determining section 175 determines whether a pointed position of the last time is also the pointed position at the contact time.

When the pointed position (n) is the pointed position at the contact time and the pointed position (n−1) of the last time is also the pointed position at the contact time, the drawing determining section 175 performs the following processing.

The drawing determining section 175 determines a drawing parameter based on moving speed of the pointer 3 at the contact time calculated based on imaging data in which the pointed position (n−1) of the last time is detected and imaging data in which the pointed position (n) of this time is detected and the drawing attribute information 165. The moving speed of the pointer 3 at the contact time is moving speed calculated by the speed calculating section 174.

When the pointed position (n) is the pointed position at the contact time and the pointed position (n−1) of the last time is the pointed position at the noncontact time, the drawing determining section 175 determines a drawing parameter based on the moving speed at the noncontact time before contact of the pointer 3 with the screen SC.

Specifically, the drawing determining section 175 determines a drawing parameter based on moving speed of the pointer 3 at the noncontact time calculated based on imaging data in which the pointed position (n−1) of the last time is detected and imaging data in which the pointed position (n−2) before the last is detected and the drawing attribute information 165. That is, when the pointed position (n) is a contact start position where the pointer 3 starts contact with the screen SC, the drawing determining section 175 determines a drawing parameter based on the moving speed of the pointer 3 at the noncontact time before contact of the pointer 3 with the screen SC.

A reason why the drawing parameter of the pointed position (n) is determined based on the moving speed of the pointer 3 at the noncontact time is explained.

For example, in the configuration in the past in which the position detecting section 171 detects only the pointed position at the contact time of the pointer 3, only a value “1.0” can be set as the first weighted value w1 in the pointed position (n), which is the contact start position. Therefore, a drawing line can be displayed only with the preset line width and the preset chroma at the contact start position.

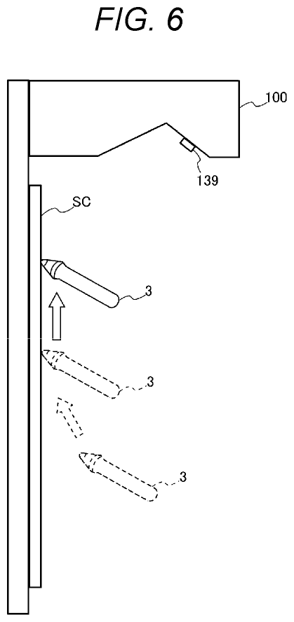

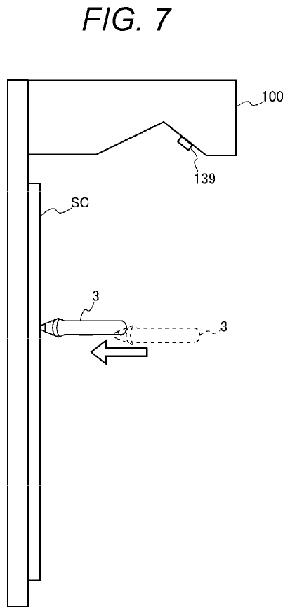

FIGS. 6 and 7 are diagrams showing an operation method for the pointer 3 with respect to the screen SC.

The following two methods are conceivable as a method of bringing the pointer 3 into contact with the screen SC. A first method is a method of bringing the tip 5 of the pointer 3 into contact with the screen SC while moving the pointer 3 in a direction substantially parallel to the surface of the screen SC as shown in FIG. 6 and moving the pointer 3 on the screen SC without stopping the pointer 3. A second method is a method of bringing the tip 5 of the pointer 3 into contact with the screen SC while moving the pointer 3 in a direction substantially parallel to the normal of the screen SC as shown in FIG. 7 and once stopping the movement of the pointer 3 and then moving the pointer 3 on the screen SC.

For example, when the pointer 3 is assumed to be a calligraphy pen and the screen SC is assumed to be paper and a character is drawn on the paper by the calligraphy pen, a line with small line width is drawn on the paper when the calligraphy pen is moved as in the first method and a line with large line width is drawn on the paper when the calligraphy pen is moved as in the second method.

In order to represent such differences of line width and chroma with a drawing line drawn on the screen SC by the pointer 3, in this embodiment, when the contact start position is detected, the first weighted value w1 is calculated based on the moving speed of the pointer 3 at the noncontact time and a drawing parameter is determined. As it is evident when FIG. 5 is referred to, the first weighted value w1 is smaller as the moving speed (v) of the pointer 3 is higher. Therefore, a value of the drawing parameter is also smaller. As the moving speed of the pointer 3 at the noncontact time is higher, it is possible to cause the screen SC to display a drawing line with small line width and small chroma.

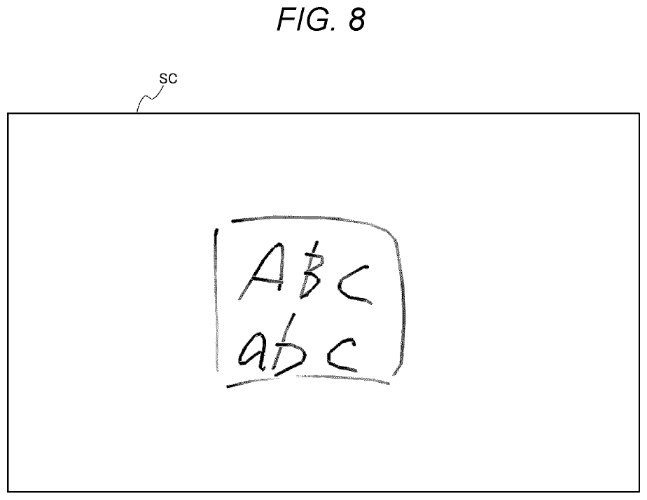

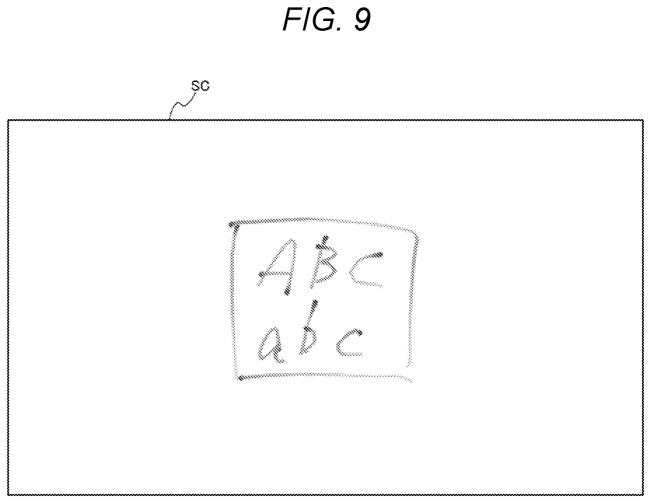

FIGS. 8 and 9 are diagrams showing drawn images displayed on the screen SC.

FIG. 8 shows a drawn image drawn by the pointer 3 that is set such that changes in line width and chroma are small even if the moving speed of the pointer 3 is changed. FIG. 9 shows a drawn image drawn by the pointer 3 of this embodiment that is set such that line width is smaller and chroma is smaller as the moving speed of the pointer 3 is higher. As it is evident when FIG. 8 and FIG. 9 are compared, the changes in the line width and the chroma are large in the drawn image shown in FIG. 9.

For example, when the moving speed of the pointer 3 is high, by setting the first weighted value w1 to a small value such as “0.2” and “0.3”, the line width is smaller and the chroma is lower as the moving speed of the pointer 3 is moved faster. That is, the user can draw characters and the like in the same feeling as an analog pen. By setting the first weighted value w1 in the case of high moving speed to a large value such as “0.8” or “0.9”, the changes in the line width and the chroma can be reduced even if the moving speed of the pointer 3 is increased.

### Operation of the Pointer

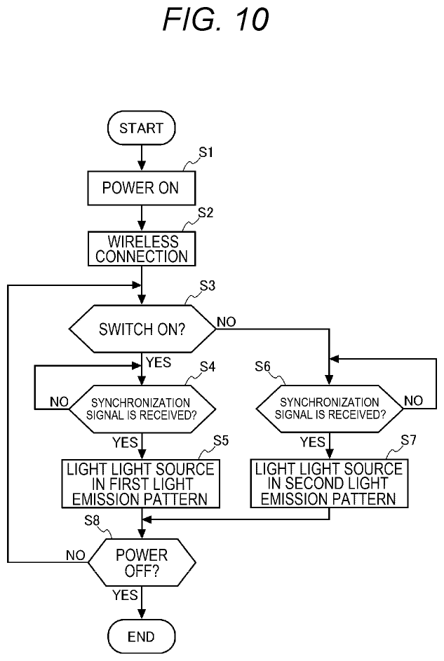

FIG. 10 is a flowchart showing the operation of the pointer 3.

When the power button is turned on and the pointer 3 starts (step S1), the pointer control section 36 executes wireless connection to the projector 100 (step S2). For example, in the case of connection by Bluetooth, the pointer control section 36 shifts to a pairing mode for performing pairing and outputs a pairing start signal from the wireless communication section 32. When receiving a response signal to the pairing start signal from the projector 100, the pointer control section 36 transmits an identification ID of the pointer 3 to a transmission source device of the response signal. The identification ID of the pointer 3 is an ID used in the wireless communication by Bluetooth. When the transmission of the identification ID is completed, the pointer 3 ends the pairing mode and shifts to a normal operation mode.

Subsequently, the pointer control section 36 determines whether the switch 34 is turned on (step S3). When the switch 34 is turned on (YES in step S3), the pointer control section 36 determines whether the pointer control section 36 receives a synchronization signal from the projector 100 (step S4). When not receiving the synchronization signal (NO in step S4), the pointer control section 36 puts execution of the processing on standby until the pointer control section 36 receives the synchronization signal.

When receiving the synchronization signal from the projector 100 (YES in step S4), the pointer control section 36 causes the light source 33 to emit light in a first light emission pattern based on reception timing of the synchronization signal (step S5). The first light emission pattern is a light emission pattern for causing the light source 33 to emit light simultaneously with the reception of the synchronization signal and maintaining the light emission of the light source 33 for a preset ON time from the light emission.

When determining in step S3 that the switch 34 is not turned on (NO in step S3), the pointer control section 36 determines whether the pointer control section 36 receives a synchronization signal (step S6). When not receiving the synchronization signal (NO in step S6), the pointer control section 36 stays on standby until the pointer control section 36 receives the synchronization signal. When receiving the synchronization signal (YES in step S6), the pointer control section 36 causes the light source 33 to emit light in a second light emission pattern (step S7). The second light emission pattern is a light emission pattern for staying on standby for a fixed time from the reception of the synchronization signal and, after elapse of the fixed time, causing the light source 33 to emit light for the ON time.

Subsequently, the pointer control section 36 determines whether the pointer control section 36 receives operation for turning off the power button (step S8). When not receiving the operation for turning off the power button (NO in step S8), the pointer control section 36 returns to step S3 and determines whether the switch 34 is on or off. When receiving the operation for turning off the power button (YES in step S8), the pointer control section 36 ends this processing flow.

### Operation of the Projector in the First Embodiment

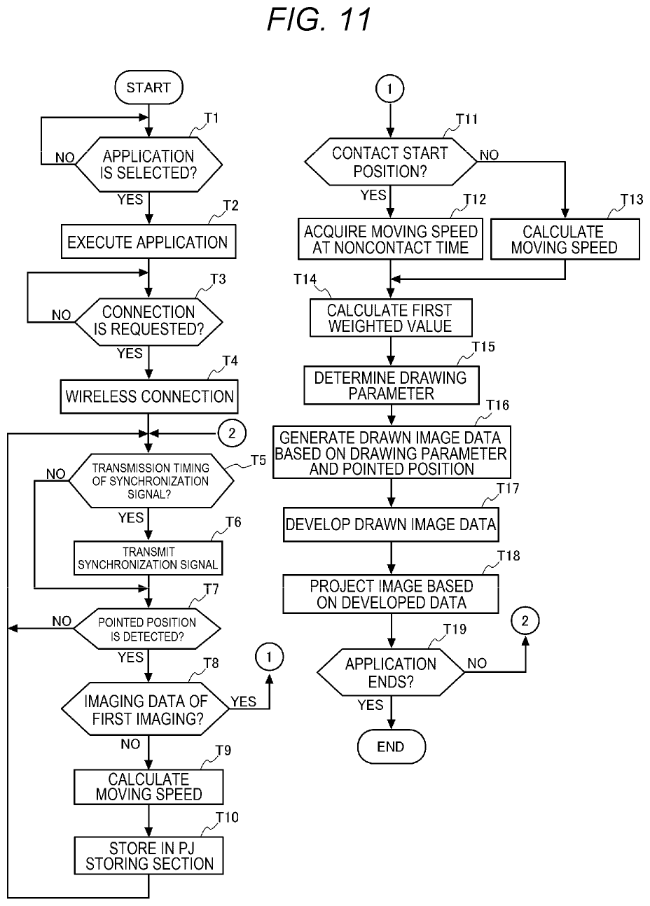

FIG. 11 is a flowchart showing the operation of the projector 100 in the first embodiment. The operation of the projector 100 is explained with reference to the flowchart of FIG. 11.

The PJ control section 150 starts processing when receiving operation for selecting an application program for realizing an interactive function. When not receiving the operation for selecting an application program (NO in step T1), the PJ control section 150 puts the start of the processing on standby until an application program is selected.

When receiving the operation for selecting an application program (YES in step T1), the PJ control section 150 executes the application program (step T2) and performs control conforming to the application program. First, the PJ control section 150 determines whether connection is requested (step T3).

For example, when the projector 100 and the pointer 3 are connected by Bluetooth, the PJ control section 150 determines whether the PJ control section 150 receives a pairing start signal. The PJ control section 150 determines whether connection is requested. When determining that the PJ control section 150 receives the pairing start signal and connection is requested (YES in step T3), the PJ control section 150 performs wireless connection to a connection request source (step T4). The PJ control section 150 transmits a response signal to the pointer 3 at the transmission source of the pairing start signal and receives an identification ID from the pointer 3. The PJ control section 150 causes the PJ storing section 160 to store the identification ID of the pointer 3 received from the pointer 3 and completes pairing. When not receiving the pairing start signal (NO in step T3), the PJ control section 150 stays on standby until the PJ control section 150 receives the pairing start signal.

Subsequently, the PJ control section 150 determines whether it is transmission timing for transmitting a synchronization signal (step T5). When it is not the transmission timing of the synchronization signal (NO in step T5), the PJ control section 150 shifts to determination in step T7. When it is the transmission timing of the synchronization signal (YES in step T5), the PJ control section 150 transmits the synchronization signal with the wireless communication section 137 (step T6).

Subsequently, the PJ control section 150 acquires imaging data captured by the imaging section 139 and analyzes the acquired imaging data. The imaging data is represented as imaging data (m). “m” is any integer equal to or larger than 1. The PJ control section 150 analyzes the imaging data (m), detects emitted light of the pointer 3, and detects a pointed position pointed by the pointer 3 (step T7). When the PJ control section 150 fails to detect the pointed position from the imaging data (m) (NO in step T7), the PJ control section 150 returns to step T5 and determines whether it is the transmission timing of a synchronization signal. When the PJ control section 150 detects the pointed position from the imaging data (m), the PJ control section 150 determines whether the imaging data (m) is imaging data of the first imaging (step T8).

When the imaging data (m) is not the imaging data of the first imaging and is imaging data of the second imaging (NO in step T8), the PJ control section 150 calculates moving speed of the pointer 3 (step T9). The PJ control section 150 determines whether imaging data in which a pointed position is detected immediately before the imaging data (m) is the imaging data of the second imaging. The imaging data is represented as imaging data (m−1). When the imaging data (m−1) is the imaging data of the second imaging, the PJ control section 150 calculates moving speed of the pointer 3 at the noncontact time based on the pointed positions detected from the imaging data (m−1) and the imaging data (m) and a difference between times when the imaging data (m) and (m−1) are captured. The PJ control section 150 causes the PJ storing section 160 to store the calculated moving speed of the pointer 3 as moving speed of the pointer 3 at the noncontact time (step T10). When the imaging data (m−1) is the imaging data of the first imaging, the PJ control section 150 shifts a target to the next imaging data and detects a pointed position from the next imaging data. The next imaging data is represented as imaging data (m+1).

When the imaging data (m) is the imaging data of the first imaging (YES in step T8), the PJ control section 150 determines whether the pointed position detected in step T7 is the contact start position (step T11). The PJ control section 150 determines whether the imaging data (m−1) is the imaging data of the second imaging and determines whether the pointed position detected in step T7 is the contact start position. When the pointed position detected in step T7 is not the contact start position (NO in step T11), the PJ control section 150 detects a pointed position from the imaging data (m+1) input next. The PJ control section 150 calculates moving speed of the pointer 3 based on the pointed positions detected from the imaging data (m) and (m+1) and a difference between times when the imaging data (m) and (m+1) are captured (step T13).

When the pointed position detected in step T7 is the contact start position (YES in step T11), the PJ control section 150 acquires moving speed of the pointer 3 at the noncontact time from the PJ storing section 160 (step T12). The acquired moving speed of the pointer 3 at the noncontact time is, for example, the moving speed calculated in step T9. Subsequently, the PJ control section 150 calculates the first weighted value w1 according to the above Expression (1) using the moving speed acquired in step T12 or the moving speed calculated in step T13 and the drawing attribute information 165 (step T14). The PJ control section 150 determines a drawing parameter according to the calculated first weighted value w1 (step T15). Subsequently, the PJ control section 150 generates drawn image data based on the determined drawing parameter and the pointed position of the pointer 3 detected in step T7 (step T16).

After generating the drawn image data, the PJ control section 150 outputs the generated drawn image data to the image processing section 143. The image processing section 143 develops the drawn image data input from the PJ control section 150 on the frame memory 145 (step T17). When the projector 100 has already projected image data supplied from the image supply apparatus 200 onto the screen SC, the image data is developed on the frame memory 145. In this case, the image processing section 143 superimposes the drawn image data input from the PJ control section 150 on the developed image data. That is, the image processing section 143 rewrites image data already developed in an address of the frame memory 145, on which the drawn image data is scheduled to be developed, to the drawn image data.

After developing the drawn image data on the frame memory 145, the image processing section 143 reads out the developed data from the frame memory 145 and outputs the developed data to the light modulating device driving circuit 123. The light modulating device driving circuit 123 drives the light modulating elements of the light modulating device 113 based on the developed data input from the image processing section 143 and causes the light modulating elements to draw images based on the developed data. Consequently, light emitted from the light source 111 is modulated by the light modulating device 113 and image light based on the developed data is generated. The generated image light is projected onto the screen SC by the optical unit 115 (step T18). A projection image is displayed on the screen SC.

Subsequently, the PJ control section 150 determines whether the PJ control section 150 receives operation for ending the application program (step T19). When not receiving the operation for ending the application program (NO in step T19), the PJ control section 150 repeats the processing from the determination of step T5. When receiving the operation for ending the application program (YES in step T19), the PJ control section 150 ends this processing flow.

As explained above, the projector 100 in the first embodiment includes the position detecting section 171, the generating section 172, the projecting section 110 corresponding to an example of the display section, the speed calculating section 174, and the drawing determining section 175.

The position detecting section 171 detects the position of the pointer 3.

The generating section 172 generates an image corresponding to the position of the pointer 3 detected by the position detecting section 171 while the pointer 3 is in contact with the screen SC corresponding to an example of the input surface.

The projecting section 110 displays the image generated by the generating section 172.

The speed calculating section 174 calculates moving speed of the pointer 3.

The drawing determining section 175 determines a form of an image based on the moving speed of the pointer 3. The drawing determining section 175 determines, based on moving speed of the pointer 3 before contact of the pointer 3 with the screen SC, a form of an image corresponding to the position of the pointer 3 detected when the pointer 3 comes into contact with the screen SC.

Therefore, the form of the image displayed on the screen SC can be changed according to the moving speed of the pointer 3 before the contact of the pointer 3 with the screen SC. Accordingly, it is possible to easily change the form of the displayed image.

The generating section 172 draws a line serving as an image along a track of the position of the pointer 3. The drawing determining section 175 determines, based on the moving speed of the pointer 3 before the contact of the pointer 3 with the screen SC, at least one of line width, chroma, and transmittance of a line to be drawn.

Therefore, it is possible to change, based on the moving speed of the pointer 3 before the contact of the pointer 3 with the screen SC, at least one of line width, chroma, and transmittance of a line to be drawn.

The drawing determining section 175 calculates a weighted value for changing, according to the moving speed of the pointer 3, at least one of the line width, the chroma, and the transmittance of the line to be drawn and determines at least one of the line width, the chroma, and the transmittance of the line based on the calculated weighted value.

Therefore, it is possible to draw, on the screen SC, with the pointer 3, a line having line width, chroma, or transmittance corresponding to the moving speed of the pointer 3.

The projector 100 includes the imaging section 139 that images a range including the screen SC. The position detecting section 171 detects the position of the pointer 3 based on imaging data obtained by imaging light of the pointer 3 that emits light.

Therefore, it is possible to accurately detect the position of the pointer 3.

The imaging section 139 performs imaging in synchronization with a light emission cycle of the pointer 3 that cyclically emits light.

Therefore, it is possible to improve detection accuracy of the position of the pointer 3.

The screen SC functioning as the input screen also functions as the display surface of the projecting section 110.

Therefore, it is possible to display an image in a position pointed by the pointer 3.

### Second Embodiment

A second embodiment of the present disclosure is explained. The configurations of the pointer 3 and the projector 100 in this embodiment are the same as the configurations of the pointer 3 and the projector 100 in the first embodiment shown in FIGS. 2 and 3. Therefore, explanation concerning the configurations of the pointer 3 and the projector 100 is omitted.

In the second embodiment, a first weighted value w1 and a second weighted value w2 are used as weighted values used for determination of drawing parameters. The PJ control section 150 selects one of the first weighted value w1 and the second weighted value w2 based on the moving speed of the pointer 3 and determines drawing parameters based on the selected weighted value.

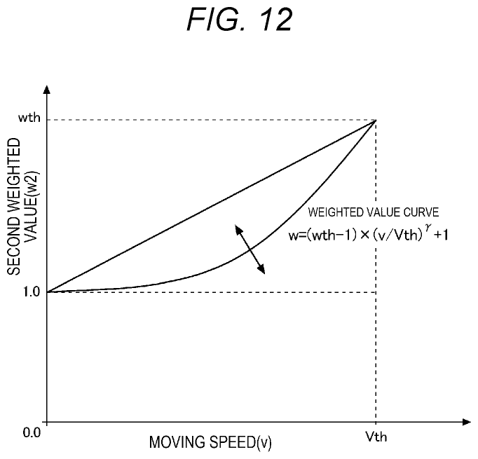

FIG. 12 is a diagram showing a weighted value curve.

The vertical axis of FIG. 12 indicates the second weighted value w2 and the horizontal axis of FIG. 12 indicates the moving speed v of the pointer 3.

When the moving speed of the pointer 3 is “0”, the second weighted value w2 is set to a minimum value “1.0”. When the moving speed of the pointer 3 is a threshold “Vth”, which is an upper limit of the moving speed, the second weighted value w2 is set to a maximum value “wth”. “wth” is information included in the drawing attribute information 165 and is information that defines the maximum value of the second weighted value w2.

The second weighted value w2 can be calculated by the following Expression (2) using, for example, the moving speed “v” of the pointer 3, the threshold “Vth” of the moving speed, gamma “γ”, and the maximum value “wth” of the second weighted value w2 as variables.

w2=(wth−1)×(v/Vth)^{γ}+1 (2)

For example, it is assumed that characters are written on paper using an analog pen such as a calligraphy pen. In this case, when the analog pen is moved as in the second method shown in FIG. 7, the tip of the analog pen is instantaneously crushed. Therefore, a line thicker than original thickness is drawn on the paper. Similarly, concerning chroma, since ink is strongly ejected by a large impulse, a line having high chroma is drawn.

In this embodiment, a weighted value used for determination of drawing parameters is selected based on a difference between moving speed of the pointer 3 immediately before coming into contact with the screen SC and moving speed of the pointer 3 when coming into contact with the screen SC.

For example, immediately after the pointer 3 comes into contact with the screen SC with the large impulse, the pointer 3 is instantaneously stopped. Therefore, moving speed of the pointer 3 immediately after the contact is small. In this way, in a state in which the moving speed of the pointer 3 suddenly decreases immediately after the pointer 3 comes into contact with the screen SC, it can be determined that the pointer 3 comes into contact with the screen SC with the large impulse. For example, when the moving speed of the pointer 3, which is 2 m/s at the noncontact time, changes to 0.01 m/s immediately after the contact, it can be determined that the pointer 3 comes into contact with the screen SC with the large impulse.

The PJ control section 150 in this embodiment calculates a difference between the moving speed of the pointer 3 immediately before coming into contact with the screen SC and the moving speed of the pointer 3 when coming into contact with the screen SC and compares the difference between the moving speeds with a preset first threshold. When the difference between the moving speeds is larger than the preset first threshold, the PJ control section 150 determines that the pointer 3 comes into contact with the screen SC with the large impulse, calculates the second weighted value w2, and determines drawing parameters. The second weighted value w2 determined by the drawing determining section 175 is a variable larger than “1.0”. Therefore, the line width of a drawing line can be changed to be thicker than reference line width. The chroma of the drawing line can be changed to be higher than reference chroma.

When the difference between the moving speeds is equal to or smaller than the first threshold, the PJ control section 150 determines that the pointer 3 comes into contact with the screen SC with a small impulse, calculates the first weighted value w1, and determined drawing parameters.

The PJ control section 150 may compare the difference between the moving speeds and the first threshold and compare the moving speed of the pointer 3 when coming into contact with the screen SC with the second threshold.

When the difference between the moving speeds is larger than the first threshold, the PJ control section 150 further determines whether the moving speed of the pointer 3 when coming into contact with the screen SC is smaller than the second threshold. When the moving speed of the pointer 3 when coming into contact with the screen SC is smaller than the second threshold, the PJ control section 150 calculates the second weighted value w2 and determines drawing parameters. That is, when the pointer 3 comes into contact with the screen SC and the moving speed of the pointer 3 is so small that the pointer 3 can be determined as once stopping on the screen SC, the PJ control section 150 calculates the second weighted value w2 and determines drawings parameters.

When the difference between the moving speeds is equal to or smaller than the first threshold or when the moving speed of the pointer 3 when coming into contact with the screen SC is equal to or larger than the second threshold, the PJ control section 150 calculates the first weighted value w1 and determines drawing parameters.

The PJ control section 150 may not perform processing for comparing the difference between the moving speeds with the first threshold and, when the moving speed of the pointer 3 when coming into contact with the screen SC is smaller than the second threshold, may calculate the second weighted value w2 and determine drawing parameters.

### Operation of the Projector in the Second Embodiment

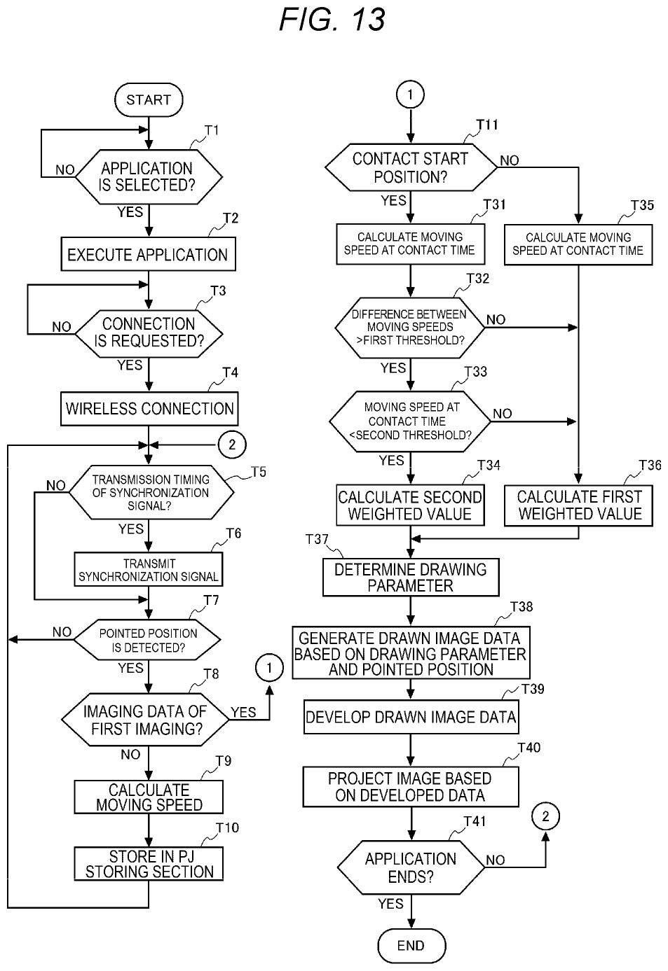

FIG. 13 is a flowchart showing the operation of the projector 100 in the second embodiment.

The operation of the projector 100 in the second embodiment is explained with reference to the flowchart of FIG. 13. A flow of processing in steps T1 to T11 shown in FIG. 13 is the same as the flow of the processing explained with reference to FIG. 11. Therefore, explanation of the flow of the processing is omitted.

When imaging data in which a pointed position is detected is the imaging data of the first imaging (YES in step T8), the PJ control section 150 determines whether the pointed position detected in step T7 is the contact start position (step T11). The PJ control section 150 determines whether the imaging data (m−1) is the imaging data of the second imaging and determines whether the pointed position detected in step T7 is the contact start position.

When the pointed position detected in step T7 is not the contact start position (NO in step T11), the PJ control section 150 calculates moving speed at the contact time (step T35). In this case, the PJ control section 150 calculates moving speed of the pointer 3 based on pointed positions detected by the imaging data (m−1) and (m) and a difference between times when the imaging data (m−1) and (m) are captured (step T35). After calculating the moving speed of the pointer 3, the PJ control section 150 calculates the first weighted value w1 according to Expression (1) based on the calculated moving speed of the pointer 3 and the drawing attribute information 165 (step T36).

When the pointed position detected in step T7 is the contact start position (YES in step T11), the PJ control section 150 calculates moving speed at the contact time (step T31). In this case, the PJ control section 150 calculates moving speed at contact time of the pointer 3 based on pointed positions detected by the imaging data (m) and the next imaging data (m+1) of the imaging data (m) and a difference between times when the imaging data (m) and (m+1) are captured (step T31).

Subsequently, the PJ control section 150 calculates a difference between the moving speed at the contact time calculated in step T31 and moving speed at the noncontact time stored in the PJ storing section 160 and compares the calculated difference between the moving speeds with the first threshold (step T32). When the difference between the moving speeds is equal to or smaller than the first threshold (NO in step T32), the PJ control section 150 shifts to processing in step T36.

When the difference between the moving speeds is larger than the first threshold (YES in step T32), the PJ control section 150 compares the moving speed at the contact time with the second threshold (step T33). When the calculated moving speed is smaller than the second threshold (YES in step T33), the PJ control section 150 calculates the second weighting value w2 according to Expression (2) based on the moving speed at the contact time and the drawing attribute information 165 (step T34). When the calculated moving speed is equal to or larger than the second threshold (NO in step T33), the PJ control section 150 calculates the first weighted value w1 according to Expression (1) based on the moving speed at the contact time and the drawing attribute information 165 (step T36).

Subsequently, the PJ control section 150 determines drawing parameters based on the second weighted value w2 calculated in step T34 or the first weighted value w1 calculated in step T36 (step T37). Processing in step S37 and subsequent steps is the same as the processing in steps T16 to T19 shown in FIG. 11. Therefore, explanation of the processing is omitted.

As explained above, with the projector 100 in the second embodiment, it is possible to obtain the same effects as the effects of the projector 100 in the first embodiment and further obtain effects explained below.

The drawing determining section 175 determines the form of the drawing line based on the difference between the moving speed of the pointer 3 before coming into contact with the screen SC and the moving speed of the pointer 3 after coming into contact with the screen SC. Therefore, it is possible to easily change a form of an image to be displayed.

The drawing determining section 175 calculates the first weighted value w1 when the moving speed of the pointer 3 when coming into contact with the screen SC is equal to or larger than the lower limit threshold. The drawing determining section 175 calculates the second weighted value when the moving speed of the pointer 3 when coming into contact with the screen SC is smaller than the lower limit threshold. When the moving speed of the pointer 3 changes in the increasing direction, the first weighted value decreases and the second weighted value increases.

Therefore, it is possible to change line width, chroma, or transmittance in an opposite direction according to whether the moving speed of the pointer 3 when coming into contact with the screen SC is smaller than the lower limit threshold.

The embodiments explained above are preferred embodiments of the present disclosure. However, the embodiments are not limited to this. Various modified implementations are possible within a range not departing from the gist of the present disclosure.

For example, the first weighted value w1 and the second weighted value w2 used for the determination of a drawing parameter of line width and the first weighted value w1 and the second weighted value w2 used for the determination of a drawing parameter of chroma may be separately calculated. By using the different weighted values w when determining the drawing parameters of the line width and the chroma, it is possible to more finely set the line width and the chroma according to a sense of the user. When the same weighted values are used to determine the drawing parameters of the line width and the chroma, it is possible to reduce a processing load of the processor 170.

In the embodiments explained above, an image is drawn on the screen SC by operating one pointer 3. However, the number of pointers 3 may be plural. In this case, when starting wireless communication with the projector 100, the wireless communication section 32 of the pointer 3 transmits preset identification information of the pointer 3 to the projector 100.

The projector 100 divides the ON period in the light emission period shown in FIG. 4 into a plurality of periods. For example, when receiving identification information from two pointers 3, the projector 100 divides the light emission period shown in FIG. 4 into two periods of a former half period and a latter half period. The projector 100 sets the pointer 3 caused to emit light in the former half period and the pointer 3 caused to emit light in the latter half period. The projector 100 causes the PJ storing section 160 to store information for defining the former half period and identification information of the pointer 3 caused to emit light in the former half period in association with each other. The projector 100 causes the PJ storing section 160 to store information for defining the latter half period and identification information of the pointer 3 caused to emit light in the latter half period in association with each other. The information for defining the former half period and the information for defining the latter half period are set based on an elapsed time after a synchronization signal is transmitted to the pointer 3.

The projector 100 transmits the information indicating the former half period to the pointer 3 caused to emit light in the former half period and transmits the information indicating the latter half period to the pointer 3 caused to emit light in the latter half period. For example, when the light emission period shown in FIG. 4 is 1 sec, the information indicating the former half period is information indicating a period of 0 to 0.5 msec after the reception of the synchronization signal and the information indicating the latter half period is information indicating a period of 0.5 msec to 1.0 msec after the reception of the synchronization signal.

The pointers 3 receive the synchronization signal and, when the switch 34 is on, cause the light source 33 to emit light at the light emission timing notified from the projector 100.

In the embodiments explained above, the drawing determining section 175 calculates the first weighted value w1 based on the above Expression (1) and determines the drawing parameters based on the calculated first weighted value w1. As a form other than this, a configuration may be adopted in which the gamma, the threshold Vth, and the moving speed are set as variables and a table in which values of the variables and the first weighted value w1 determined based on the values of the variables are registered in association with each other is stored in the PJ storing section 160 in advance. The same applies to the second weighted value w2.

In the first and second embodiments, the projector 100 transmits the synchronization signal to the pointer 3 with the wireless communication section 137. However, a transmitting section for an infrared signal may be provided in the projector 100.

The projector 100 transmits the infrared signal as the synchronization signal. The pointer 3 causes the light source 33 to emit light based on timing when the infrared signal is received. By adopting such a configuration, it is unnecessary to separately provide the wireless communication sections 32 and 137 in the projector 100 and the pointer 3.

Identification information of the pointer 3 may be included in the infrared signal transmitted by the projector 100. The pointer 3 causes the light source 33 to emit light when the identification information included in the received infrared signal is identification information allocated to the pointer 3. By adopting such a configuration, it is possible to draw an image on the screen SC using a plurality of pointers 3.

In the first and second embodiments explained above, the projector 100 generates the drawing parameters that define the line width and the chroma of the drawing line of the projector 100. Besides, the projector 100 may generate a drawing parameter that defines the transmittance of the drawing line.

Processing units of the flowcharts of FIGS. 10, 11, and 13 are divided according to main processing contents in order to facilitate understanding of the processing. The present disclosure is not limited by a method of division and names of the processing units. According to processing contents, the processing units may be divided into a larger number of processing units or may be divided such that one processing unit includes a larger number of kinds of processing. The order of the processing may be changed as appropriate without hindering the gist of the present disclosure.

In the embodiments explained above, the projector 100, which is the display apparatus, includes the functions of the “position detecting section”, the “generating section”, and the like. However, the “position detecting section”, the “generating section”, and the like can also be realized by an apparatus other than the projector 100. For example, at least a part of the functions of the “position detecting section”, the “generating section”, the “speed calculating section”, and the “drawing determining section” may be realized by an apparatus other than the projector 100 such as a personal computer. For example, at least a part of the functions of the “position detecting section”, the “generating section”, the “speed calculating section”, and the “drawing determining section” may be realized by application programs installed in the personal computer.

The functional sections shown in FIGS. 2 and 3 indicate functional components. Specific implementation forms of the functional sections are not particularly limited. That is, hardware individually corresponding to the functional sections does not always need to be implemented. It is naturally possible to adopt a configuration in which one processor executes programs to realize functions of a plurality of functional sections. A part of the functions realized by software in the embodiments explained above may be realized by hardware. Alternatively, a part of the functions realized by hardware in the embodiment may be realized by software. The specific detailed configurations of the other sections of the pointer 3 and the projector 100 can also be optionally changed without departing from the gist of the present disclosure.

When the display method is realized using a computer included in the display apparatus, programs executed by the computer can also be configured in a form of a recording medium or a transmission medium that transmits the programs. A magnetic or optical recording medium or a semiconductor memory device can be used as the recording medium. Specifically, examples of the recording medium include a flexible disk, a HDD (Hard Disk Drive), a CD-ROM (Compact Disk Read Only Memory), a DVD, a Blu-ray Disc, and a magneto-optical disk. Blue-ray is a registered trademark. Examples of the recording medium further include a flash memory and a portable or stationary recording medium such as a card-type recording medium. The recording medium may be a RAM (Random. Access Memory) or a ROM (Read Only Memory), which is an internal storage device included in the display apparatus, or a nonvolatile storage device such as a HDD.

What is claimed is:

1. A display apparatus comprising:
a position detecting section configured to detect a position of a pointer;
a generating section configured to generate an image corresponding to a position of the pointer detected by the position detecting section while the pointer is in contact with an input surface;
a display section configured to display the image generated by the generating section;
a speed calculating section configured to calculate moving speed of the pointer; and
a drawing determining section configured to determine a form of the image based on the moving speed of the pointer, wherein
the drawing determining section determines, based on moving speed of the pointer before coming into contact with the input surface, a form of the image corresponding to a position of the pointer detected when coming into contact with the input surface.

2. The display apparatus according to claim 1, wherein the drawing determining section determines the form of the image based on a difference between the moving speed of the pointer before coming into contact with the input surface and moving speed of the pointer after coming into contact with the input surface.

3. The display apparatus according to claim 1, wherein
the generating section draws a line serving as the image along a track of the position of the pointer, and
the drawing determining section determines at least one of line width, chroma, and transmittance of a line to be drawn.

4. The display apparatus according to claim 3, wherein the drawing determining section calculates a weighted value for changing at least one of the line width, the chroma, and the transmittance of the line to be drawn to a value corresponding to a change in the moving speed of the pointer and determines at least one of the line width, the chroma, and the transmittance of the line based on the calculated weighted value.

5. The display apparatus according to claim 4, wherein
the drawing determining section calculates a first weighted value as the weighted value when moving speed of the pointer when coming into contact with the input surface is equal to or larger than a threshold and calculates a second weighted value as the weighted value when the moving speed of the pointer when coming into contact with the input surface is smaller than the threshold,
the first weighted value decreases when the moving speed of the pointer changes in an increasing direction, and
the second weighted value increases when the moving speed of the pointer changes in the increasing direction.

6. The display apparatus according to claim 1, further comprising an imaging section configured to image a range including the input surface, wherein
the position detecting section detects the position of the pointer based on a captured image obtained by imaging light of the pointer that emits light.

7. The display apparatus according to claim 6, wherein the imaging section performs imaging in synchronization with a light emission cycle of the pointer that cyclically emits light.

8. The display apparatus according to claim 1, wherein the input surface is a display surface of the display section.

9. A display system comprising:
a pointer;
a position detecting section configured to detect a position of the pointer;
a generating section configured to generate an image corresponding to a position of the pointer detected by the position detecting section while the pointer is in contact with an input surface;
a display section configured to display the image generated by the generating section;
a speed calculating section configured to calculate moving speed of the pointer; and
a drawing determining section configured to determine a form of the image based on the moving speed of the pointer, wherein
the drawing determining section determines, based on moving speed of the pointer before coming into contact with the input surface, a form of the image corresponding to a position of the pointer detected when coming into contact with the input surface.

10. A display method comprising:
detecting a position of a pointer;
generating an image corresponding to the position of the pointer detected while the pointer is in contact with an input surface;
displaying the generated image;
calculating moving speed of the pointer; and
determining a form of the image based on the moving speed of the pointer, wherein
in the determining the form of the image, a form of the image corresponding to a position of the pointer detected when coming into contact with the input surface is determined based on moving speed of the pointer before coming into contact with the input surface.
